(19) United States
(12) Patent Application Publication
(10) Pub. No.: US 2003/0217751 A1
(43) Pub. Date: Nov. 27, 2003

(54) WASHABLE DUST MASK

(76) Inventor: Stuart Lane Patrick, Marysville, CA (US)

Correspondence Address: Stu Patrick, 2019 Hammonton RD. #21, Marysville, CA, 95901, US

(21) Appl. No.: 10/154,618

(22) Filed: May 24, 2002

(51) Int. Cl. A62B 18/08

(52) U.S. Cl. 128/205.27; 128/206.12

(57) ABSTRACT

My new mask is like dust masks and surgical masks but it's more efficient and more comfortable. The user can berathe comfortably all day through the cotton cloth I use to make said mask, and it can be reused many times because it's washable. The new built-in padded nose clamp is made of a copper wire that is plyable enough to easily bend to fit the contour of the users nose and strong enough to hold it's shape during normal use. To gather the bottom of said mask snugly under the users chin I built in some draw strings that are fastened together under the users chin with an adjustable quick fastening device. The new design, new materials and the new adjustable devices make my mask easy to use, efficient and comfortable enough to wear all day.

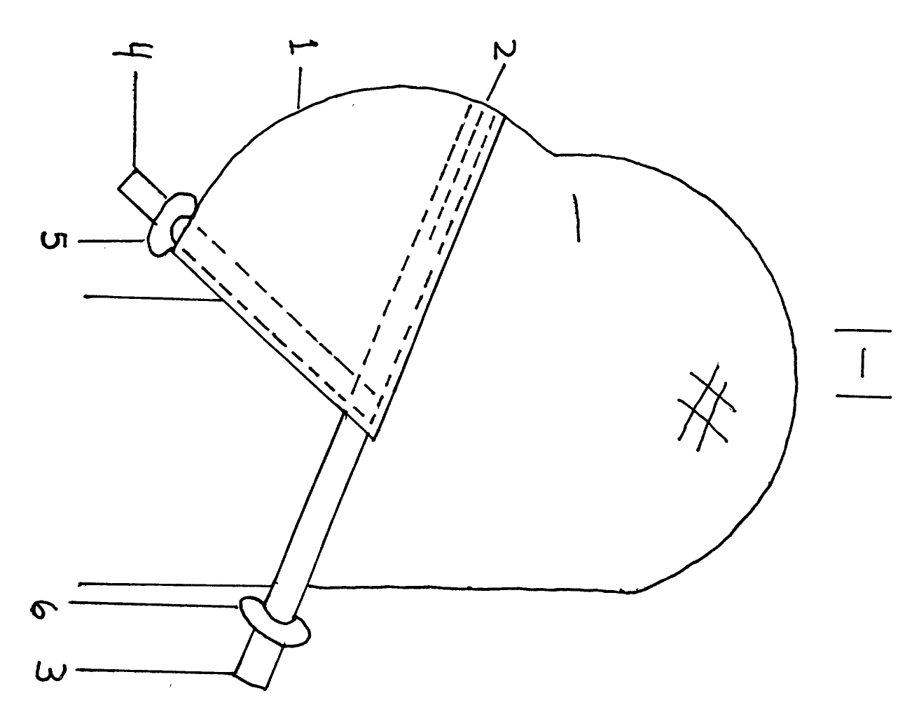

### BACKGROUND OF THE INVENTION

My mask pertains to dust masks and surgical masks. Prior masks are either inefficient, uncomfortable or both. Some masks leak exhaled breath around your nose fogging up your glasses. And some masks leak in dusty air when you inhale.

### BRIEF SUMMARY OF THE INVENTION

I designed my mask to be easy to use, comfortable enough to wear all day and to filter or capture as much dust as possible from the air you breathe. I found that cotton cloth makes the best filter because you can breathe through it comfortably all day and you can wash it any time. I found that a padded copper wire makes the best nose clamp because it's easy to bend and it holds it's shape. I designed the tie strings to be fastened on the back of your neck for maximum comfort. I designed built-in draw strings to gather the bottom of said mask snugly under your chin. I equiped the tie strings and the draw strings with adjustable quick fasten devices.

### BRIEF DESCRIPTION OF THE VIEW OF THE DRAWING

The drawing shows the left side perspective view. The dotted lines show where the built-in parts are located.

### DETAILED DESCRIPTION OF THE INVENTION

My invention is a new and improved dust mask made with one hundred percent cotton knit cloth. Said mask is efficient because it can be adjusted to make an air tight seal around the edges therefore the air the user breathes is filtered through said cloth. Said mask is comfortable because the tie strings, draw strings and the nose clamp are all adjustable. Said mask is easy to use because said tie strings and draw strings are equiped with quick fastening devices. Said mask can be reused many times because it's washable.

The parts listed below are numbered the same as the parts in the drawing of said mask.

1. The body of said mask is made with a triangle of one hundred percent cotton knit cloth with a hem across the top and down both remaning sides.

2. The nose clamp is made with a copper wire.

3. The tie strings are made of elastic strings.

4. The draw strings are made of elastic strings.

5. and 6. The quick fastening devices are made of beads.

To make said mask follow the directions below;

Install the tie strings and the copper wire into the top hem of the triangle of cloth.

Install the draw strings into the side hems.

Install the quick fastening beads onto the ends of the tie strings and the draw strings.

To use said mask you must bend the nose clamp to fit the contour of your nose and adjust the tie strings and the draw strings untill said mask fits snugly on your face.

What I claim as my invention is a new and improved washable dust mask comprising of;

1. (A) A body made with one hundred percent cotton knit cloth.
(B) A nose clamp made of eighteen gauge copper wire.
(C) The tie strings are made of elastic strings that are fastened at the back of the users neck.
(D) The built-in draw strings are made of elastic strings. Said draw strings are disigned to gather and hold the bottom of said mask snugly under the users chin.
(E) Said mask is equiped with quick fastening beads. Said beads slide snugly on the ends of said tie strings and said draw strings.

2. A dust mask as recited in claim 1. wherein said nose clamp is made of a strip of plyable, noncorosive sheet metal.

3. A dust mask with built-in strings that the user can tie under his or her chin to stop dusty air from leaking in around the bottom of said mask.
